(19) United States
(12) Patent Application Publication
(10) Pub. No.: US 2025/0370701 A1
(43) Pub. Date: Dec. 4, 2025

(54) MANAGING AUDIO ROUTING AMONG CONNECTED DEVICES RESPONSIVE TO BEING INSIDE OR OUTSIDE OF A USE SPACE

(71) Applicant: MOTOROLA MOBILITY LLC, WILMINGTON, DE (US)

(72) Inventors: AMIT KUMAR AGRAWAL, BANGALORE (IN); SHUAIB PUZHAKKAL KAVALATHARA, TIRUR (IN); SACHIN KUMAR BALERA, HOSAPALYA (IN)

(21) Appl. No.: 18/731,024

(22) Filed: May 31, 2024

(51) Int. Cl. G06F 3/16; H04B 17/318

(52) U.S. Cl. CPC G06F 3/165; H04B 17/318

(57) ABSTRACT

An electronic device, a method, and a computer program product provide automatic external audio output device switching based on sensing relative device position to a use space such as an occupant enclosure, vehicle or room. A controller of the electronic device communicates, via a wireless transceiver, an audio output signal to an external audio output device positioned in a use space. In response to a change in a sensor input indicating that a position of the electronic device has moved from inside to outside of the use space and while the external audio output device is within a communication range with the wireless transceiver, the controller configures the electronic device to selectively discontinue communicating the audio output signal to the external audio output device based on context (e.g., type of audio content). The electronic device may switch the audio output signal to an integral or wearable audio output device.

### BACKGROUND

### 1. Technical Field

The present disclosure relates generally to mobile electronic devices that present audio output, and more particularly, to mobile electronic devices that can communicate audio output to different audio output devices including an external audio output device.

### 2. Description of the Related Art

Vehicle-to-Device (V2D) communication is a type of wireless communication that enables vehicles to connect and interact with other devices, such as smartphones, tablets, and wearable devices. This communication can be used to share information between the vehicle and the other devices, allowing for greater convenience, safety, and efficiency. V2D communication relies on a combination of technologies, including Bluetooth, Wi-Fi, and cellular networks, to enable devices to wirelessly connect and communicate with vehicles. V2D communication offers several benefits to both drivers and vehicle manufacturers. In an example, V2D communication provides drivers with greater convenience and control of electronic services, allowing the driver to manage in-vehicle systems from their smartphone or from other devices. For manufacturers, V2D communication can offer new revenue streams and opportunities for innovation, such as developing new mobile apps or wearable devices that interact with vehicles. One of the most common use case of V2D communication is hands free calling using the in-vehicle audio system. Another common use case of V2D communication is supporting audio presentation of entertainment content subscribed to and access by a mobile electronic device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a communication device providing automatic pausing or switching of an audio output from an external audio output device to an integrated or wearable audio output device, based on sensing relative electronic device position to a use space, according to one or more embodiments;

FIG. 2 is a top view of the communication device in a second communication environment being used inside and outside of a vehicle use space, according to one or more embodiments;

FIG. 3 is a top view of the communication device in a third communication environment being used inside and outside of a room use space defined by an occupant enclosure, according to one or more embodiments;

FIG. 4 is a front view of a display of the communication device presenting audio routing controls interface generated by a device audio routing management module, according to one or more embodiments;

FIG. 5 is a flow diagram presenting a method of automatic pausing or switching of an audio output from an external audio output device to an integrated or wearable audio output device, based on sensing relative electronic device position to a use space such as an occupant enclosure, vehicle, or room, according to one or more embodiments;

FIG. 6 is a flow diagram presenting a method, augmenting the method of FIG. 5, of selectively communicating the audio output signal to an audio output device of the first electronic device or a wearable audio output device worn by the user, according to one or more embodiments; and

FIG. 7 is a flow diagram of a method, augmenting the method of FIG. 5, of selectively pausing communication of the audio output signal to the external audio output device based on contextual indications, according to one or more embodiments.

### DETAILED DESCRIPTION

According to aspects of the present disclosure, an electronic device, a method, and a computer program product provide automatic external audio output device switching based on sensing relative device position to a use space such as an occupant enclosure, vehicle, or room. In one or more embodiments, an electronic device includes a communication subsystem having a wireless transceiver. The electronic device also includes a sensor. A controller of the electronic device is communicatively coupled to the communication subsystem and the sensor. The controller configures the electronic device to communicate, via the wireless transceiver, an audio output signal to an external audio output device positioned in a use space. The audio output signal may be currently available and presented or may be contingent upon receiving a communication call or other trigger. The controller monitors a sensor input detected by the sensor (e.g., sound, wireless signal strength, Ultra-Wide Band (UWB) direction/range finding). In response to a change in the sensor input indicating that a position of the electronic device has moved from inside to outside of the use space and while the external audio output device is within a communication range with the wireless transceiver, the controller configures the electronic device to selectively discontinue communicating the audio output signal to the external audio output device, in part based on a context.

In one or more embodiments, discontinuing communicating the audio output signal is contingent upon the context. In an example, the electronic device determines availability of an audio output device integral to the electronic device or being worn by the user, one of which should receive the audio output signal instead of the external audio output device. In an example, device settings may designate a first priority for switching the audio output device to a wearable audio output device whenever the electronic device is outside of or a threshold distance away from the use space. When a wearable audio output device is not present, the device settings may designate switching to an integral audio output device as an alternate priority. In another example, discontinuing communicating the audio output signal is contingent upon the type of audio signal being presented and whether any other person remains within the use space.

In one or more embodiments, in response to determining that the electronic device, and presumably the user, has returned to the use space, the electronic device automatically resumes communicating the audio output signal to the external audio output device within the use space.

In one or more embodiments, the present disclosure provides a solution for a frequently occurring problem for drivers of a vehicle who use Vehicle-to-Device (V2D) communication for hands free calling or playing entertainment content such as audiobooks or music. On occasions, the person may step out of the vehicle with the mobile electronic device that is performing V2D communication. While the mobile electronic device is within a coverage area of the vehicle (e.g., within Bluetooth range), the mobile electronic device stays connected to the in-vehicle audio system. The audio for any existing or new voice (or video) call is automatically presented within the vehicle, including to any occupants that are inside of the vehicle. The audio is not presented to the intended user who is carrying the mobile electronic device outside of the vehicle and is oftentimes out of hearing range and unable to (clearly) hear the audio being presented within the vehicle. Users of generally known mobile electronic devices are required to manually switch the device audio output back to the local speakers of the mobile device and again switch back to the in-vehicle audio once the user is back inside the vehicle. The present disclosure addresses the aforementioned situation by providing automated handling of output presentation V2D communication as well as more generally presenting audio output to an appropriate audio output device when a user leaves a use space such as occupant enclosure (e.g., vehicle, room).

In an example embodiment, the present disclosure provides a solution for managing audio routing among connected devices in a connected vehicle context. First, a mobile electronic device determines that a connection exists with an in-vehicle audio system. Second, the mobile electronic device uses device sensors to monitor contextual information. In one embodiment, the context information includes a noise profile of the surrounding environment as detected by an audio sensor of the electronic device. The mobile electronic device may monitor its microphone and compare the current detected noise profile to a library of reference noise profiles. Third, the mobile device may determine whether the noise profile matches a reference in-vehicle noise profile. The noise profile may match the reference in-vehicle noise profile if the user is in a vehicle (e.g., less ambient noise). In another scenario, the noise profile may match a reference outdoors profile if the user is outdoors or walking outside of the car. Fourth, the mobile electronic device detects/determines whether the mobile electronic device is being carried out of the vehicle while the mobile device is wirelessly connected to the in-vehicle audio system. Depending on the how the car audio system is configured, the applicable scenario may include that the vehicle engine is kept ON or running. Fifth, in response to detecting the mobile electronic device being carried out of the car, the mobile electronic device re-routes/routes ongoing/incoming audio signal to an integral (speaker) or a wearable audio output device using a device audio routing management application. For example, if any phone or video call is received during this time, the device audio routing management application of the mobile electronic device automatically routes audio for the call to the integral or the wearable audio output device rather than to the in-vehicle audio system, even if the mobile electronic device is within connection range to the in-vehicle audio system. In one or more embodiments, the present disclosure may include a solution using an Ultra-Wide Band (UWB) relative distance system. UWB modules embedded respectively in the mobile electronic device and in the vehicle can more accurately determine whether the mobile electronic device user is inside or outside the vehicle. Sixth, in one or more embodiments, the mobile electronic device may automatically reroute audio back to the in-vehicle audio system once the mobile electronic device determines that the mobile electronic device, and presumably the user, is back within the vehicle.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

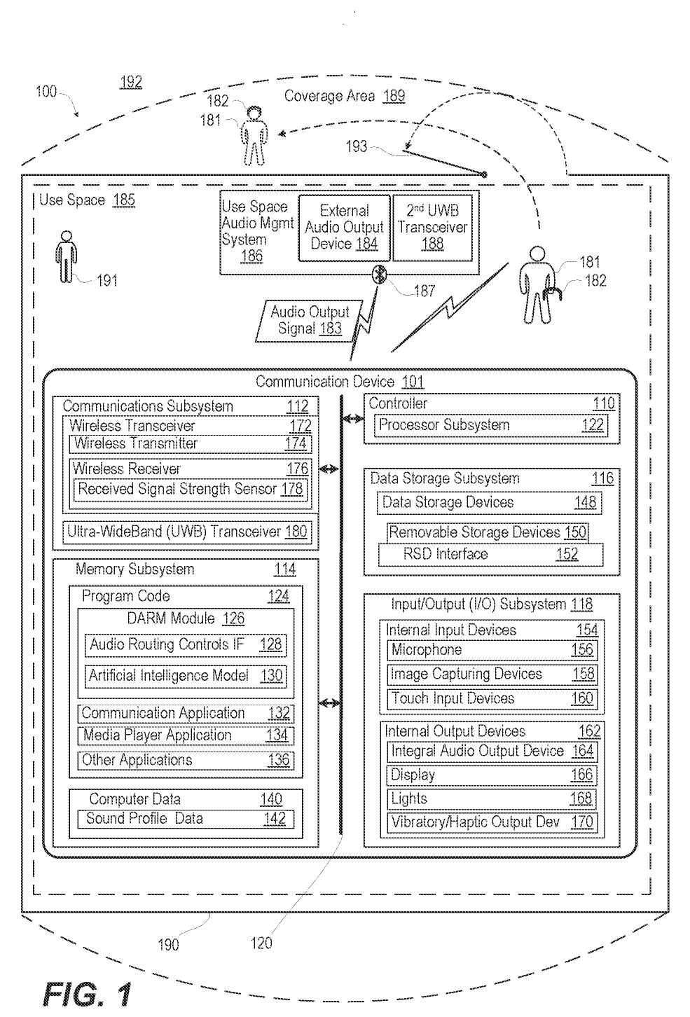

FIG. 1 presents a simplified functional block diagram of an electronic device in which the features of the present disclosure are advantageously implemented for automatic pausing or switching of an audio output from an external audio output device to an integrated or wearable audio output device, based on sensing relative electronic device position to a use space such as an occupant enclosure, vehicle, or room. In one or more embodiments, the electronic device includes additional communications functionality as communication device 101 to operate as a mobile user device in communication environment 100. Communication device 101 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 101 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices.

Communication device 101 may include controller 110, communications subsystem 112, memory subsystem 114, data storage subsystem 116 and input/output (I/O) subsystem 118. To enable management by controller 110, system interlink 120 communicatively connects controller 110 with communications subsystem 112, memory subsystem 114, data storage subsystem 116 and I/O subsystem 118. System interlink 120 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 120) are illustrated in FIG. 1, it is to be understood that more, fewer, or different interconnections may be present in other embodiments.

Controller 110 includes processor subsystem 122, which includes one or more central processing units (CPUs) or data processors. Processor subsystem 122 can include one or more digital signal processors that can be integrated with data processor(s). Processor subsystem 122 can include other processors such as auxiliary processor(s) that may act as a low power consumption, always-on sensor hub for physical sensors. Controller 110 manages, and in some instances directly controls, the various functions and/or operations of communication device 101. These functions and/or operations include, but are not limited to including, application data processing, communication with second communication devices, navigation tasks, image processing, and signal processing. In one or more alternate embodiments, communication device 101 may use hardware component equivalents for application data processing and signal processing. For example, communication device 101 may use special purpose hardware, dedicated processors, general purpose computers, microprocessor-based computers, micro-controllers, optical computers, analog computers, dedicated processors and/or dedicated hard-wired logic.

Memory subsystem 114 stores program code 124 for execution by processor subsystem 122 to provide the functionality described herein. Program code 124 includes applications such as device audio routing management (DARM) module 126, which may have audio routing controls interface 128 and artificial intelligence (AI) model 130. Program code 124 may include communication application 132 that facilitates a communication session. Program code 124 may include media player application 134 for streaming or playing back media content. Program code 124 may include other applications 136. These applications/modules may be software or firmware that, when executed by controller 110, configures communication device 101 to provide functionality described herein.

In one or more embodiments, several of the described aspects of the present disclosure are provided via executable program code of applications executed by controller 110. In one or more embodiments, program code 124 may be integrated into a distinct chipset or hardware module as firmware that operates separately from executable program code. Portions of program code 124 may be incorporated into different hardware components that operate in a distributed or collaborative manner. Memory subsystem 114 further includes operating system (OS), firmware interface, such as basic input/output system (BIOS) or Uniform Extensible Firmware Interface (UEFI), and firmware, which also includes and may thus be considered as program code 124.

Program code 124 may access, use, generate, modify, store, or communicate computer data 140, such as sound profile data 142 that supports, and is updated by, device audio routing management module 126. Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 101 or be retrieved from a remote device via communications subsystem 112. Communication device 101 may store, modify, present, or transmit computer data 140 such as sound profile data 142. Computer data 140 may be organized in one of a number of different data structures. Common examples of computer data 140 include video, graphics, text, and images. Computer data 140 can also be in other forms of flat files, databases, and other data structures.

Data storage subsystem 116 of communication device 101 includes data storage device(s) 148. Controller 110 is communicatively connected, via system interlink 120, to data storage device(s) 148. Data storage subsystem 116 provides program code 124 and computer data 140 stored on nonvolatile storage that is accessible by controller 110. For example, data storage subsystem 116 can provide a selection of program code 124 and computer data 140. These applications can be loaded into memory subsystem 114 for execution/processing by controller 110. In one or more embodiments, data storage device(s) 148 can include hard disk drives (HDDs), optical disk drives, and/or solid-state drives (SSDs), etc. Data storage subsystem 116 of communication device 101 can include removable storage device(s) (RSD(s)) 150, which is received in RSD interface 152. Controller 110 is communicatively connected to RSD 150, via system interlink 120 and RSD interface 152. In one or more embodiments, RSD 150 is a non-transitory computer program product or computer readable storage device that may be executed by a processor associated with a user device such as communication device 101. Controller 110 can access data storage device(s) 148 or RSD 150 to provision communication device 101 with program code 124 and computer data 140.

I/O subsystem 118 may include internal input devices 154 such as microphone 156, image capturing device(s) 158, and touch input devices 160 (e.g., screens, keys, or buttons). I/O subsystem 118 may include internal output devices 162 such as integral audio output devices 164, display 166, lights 168, and vibratory or haptic output devices 170.

Communications subsystem 112 includes at least one wireless transceiver 172 having wireless transmitter(s) 174 and wireless receiver(s) 176. Received signal strength sensor 178 detects a strength of a received signal, which may be used according to aspects of the present disclosure to determine range based on a known transmitter output power of a transmitter attenuating as a function of distance from the transmitter. Communications subsystem 112 may include an Ultra WideBand (UWB) transceiver 180 that may be used to determine distance and direction to another UWB transceiver.

In one or more embodiments, controller 110, via communications subsystem 112, performs multiple types of cellular over-the-air (OTA) or wireless communication, such as by using a Bluetooth connection or other personal access network (PAN) connection. In an example, user 181 may position wearable audio output device, such as a headphone or earphone for listening to audio output. Communications subsystem 112 may be communicatively coupled to wearable audio output device 182 via a wireless connection. In one or more embodiments, communications subsystem 112 includes a global positioning system (GPS) module that receives GPS broadcasts from GPS satellites to obtain geospatial location information. In one or more embodiments, controller 110, via communications subsystem 112, communicates via a wireless local area network (WLAN) link using one or more IEEE 802.11 WLAN protocols with an access point. In one or more embodiments, controller 110, via communications subsystem 112, may communicate via an OTA cellular connection with radio access networks (RANs). In an example, communication device 101, via communications subsystem 112, connects via RANs of a terrestrial network that is communicatively connected to a network server.

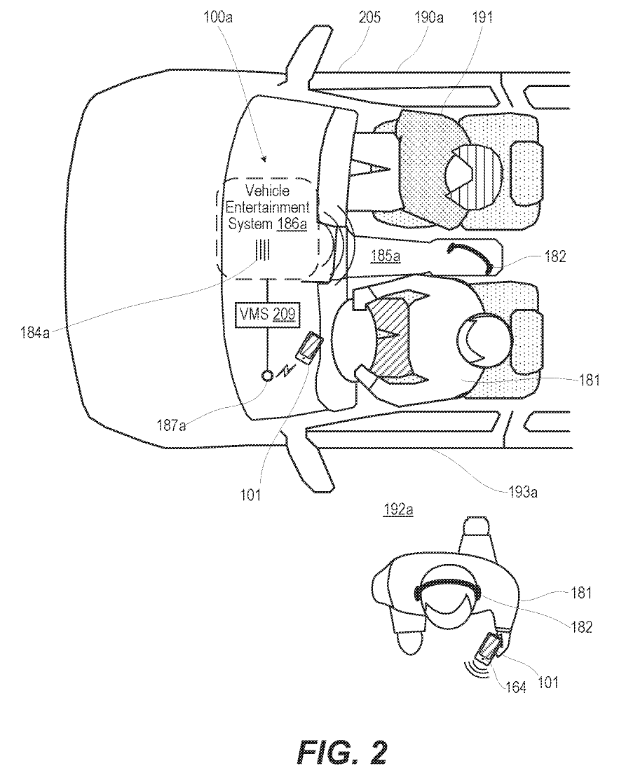

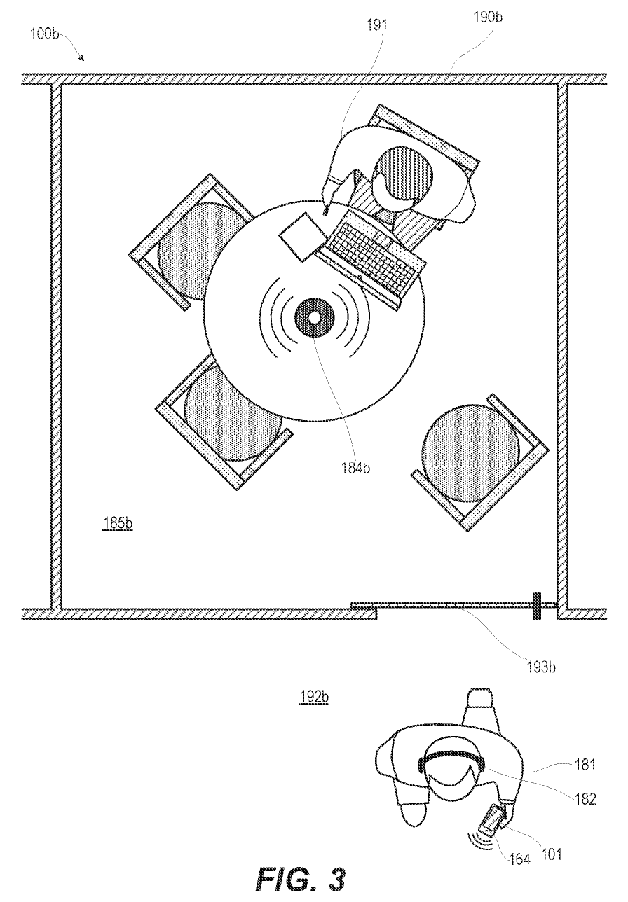

According to aspects of the present disclosure, processor subsystem 122 of controller 110 executes DARM module 126 in memory subsystem 114 configures communication device 101 communicate, via wireless transceiver 172, audio output signal 183 to external audio output device 184 positioned in use space 185. In an example, use space audio management system 186 is communicatively coupled via external transceiver 187 (e.g., Bluetooth transceiver) to communications subsystem 112 of communications device 101. Use space audio management system 186 may support second UWB transceiver 188 for facilitating location finding by communication device 101 using UWB transceiver 180. In one or more embodiments, external transceiver 187 has coverage area 189 that extends beyond use space 185. In an example, use space 185 is within occupant enclosure 190 (e.g., vehicle passenger compartment 190a of FIG. 2 or room walls 190b of FIG. 3) that is accessible by user 181 and one or more second person 191 from exterior space 192 via door 193 of occupant enclosure 190. Controller 110 monitors a sensor input detected by a sensor for determining whether communication device 101 is in use space 185 or exterior space 192. In an example, the sensor is microphone 156. In another example, the sensor is received signal strength sensor 178. In an additional example, the sensor is ULW transceiver 180. In response to a change in the sensor input indicating that a position of the communication device has moved from inside to outside of use space 185 and while external audio output device 184 is within a communication range with wireless transceiver 172 and external transceiver 187, controller 10 discontinues communicating audio output signal 183 to external audio output device 184.

DARM module 126 may be configured to automatically pause audio output at external audio output device or switch audio output to one of the local audio output devices (i.e., integral audio output device 164 or wearable audio output device 182) for presenting audio output signal, based on specific contexts. In one or more embodiments, DARM module 126 includes artificial intelligence (AI) model 130 that is trained to recognize contexts in which audio signal routing/re-routing to select audio output devices may be automated. DARM module 126 and AI model 130 may be stored in memory subsystem 114 of communication device 101 and executed by controller 110 to perform various aspects of the functionality of the present disclosure. AI model training is the process by which AI models are trained to perform specific tasks or achieve certain objectives. The training involves providing the model with a large amount of data and allowing the model to learn from patterns and relationships within that data. Controller 110 may include various functionalities that enable controller 110 to perform different aspects of AI modules. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. In one or more embodiments, AI model 130 is provided information about what application is providing audio output signal 183, what persons (e.g., 181 and 191) are in use space 185, metadata describing audio output signal 183, a source address of audio output signal 183, geographic location of use space 185, and other information. Examples of metadata include whether audio output signal 183 is prerecorded, live, entertainment, one-way communication, or two-way communication, etc. Geographic information may indicate whether user 181 leaves user space 185 to enter a store, a church, a public street, etc. that are associated with different acceptable uses of internal device loudspeakers or wearables. When user 181 manually reconfigures the communication device 101 to pause or switch communicating audio output signal 183, AI model 130 is trained to recognize patterns in the user behavior that correlates or does not correlate to the context.

FIG. 2 is a top view of communication device 101 in communication environment 100a that includes the inside and outside of vehicle use space 185a (i.e., passenger compartment) defined by vehicle passenger compartment 190a. While in vehicle use space 185a of vehicle 205, user 181 may use communication device 101 hands free when connected to vehicle external transceiver 187a (e.g., Bluetooth transceiver or wireless hotspot) of vehicle management system 209 or part of vehicle entertainment system 186a having a vehicle exterior audio output device 184a for audio output originating from communication device 101. User 181 may leave vehicle user space 185a via door 193a of vehicle 205, and transition/move to exterior space 192a, which is within communication range of external transceiver 187a. While located at/in exterior space 192a, communication device 101 can remain connected to external audio output device 184a and user 181 is able to hear or be heard by vehicle entertainment system 186a. Second person 191 may remain in vehicle 205. User 181 may put on wearable audio output device 182 to continue listening, or be ready to listen, to audio output originating from communication device 101. Alternatively, communication device 101 may include integral audio output device 164 as a loudspeaker or earpiece speaker to locally broadcast/present the audio output.

FIG. 3 is a top view of communication device 101 in communication environment 100b that is the inside and outside of room use space 185b (e.g., conference room) defined by walled room walls 190b. While in room use space 185b, user 181 may use communication device 101 by connecting to external audio output device 184b to present audio output presented from/by communication device 101. User 181 may leave room use space 185b via door 193b with communication device 101 and be in exterior space 192b within communication range of exterior audio output device 184b. While located at/in exterior space 192b, communication device 101 can remain connected to external audio output device 184b and user 181 is able to hear or be heard by exterior audio output device 184. Second person 191 may remain in room use space 185b. Similar to FIG. 2, user 181 may put on wearable audio output device 182 to continue listening, or be ready to listen, to audio output originating from communication device 101. Alternatively, communication device 101 may include integral audio output device 164 such as a loudspeaker or earpiece speaker to locally broadcast/present the audio output.

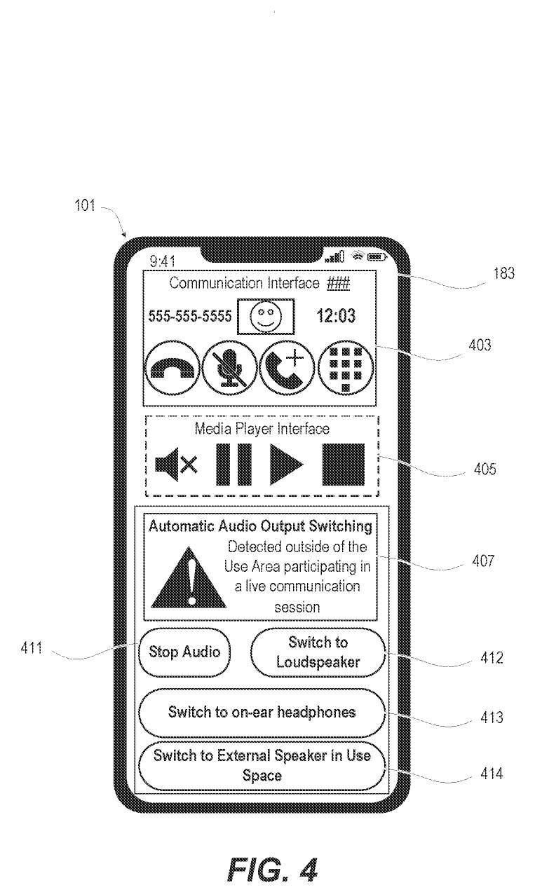

FIG. 4 is a front view of display 166 of communication device 101 presenting audio routing controls interface 128 generated by DARM module 126. Display 166 also presents communication interface 403 for communication application 132 (FIG. 1) and media player interface 405 for media player application 134 (FIG. 1). In one or more embodiments, during a training mode for training AI module 130 (FIG. 1) or to allow user 181 (FIG. 1) to override automated audio switching, communication device 101 presents, on display 166, status of recommendations 407 for audio switching in training mode or status of automated audio switching. Display 166 is configured to present manual audio routing controls “Stop Audio” 411, “Switch to Loudspeaker” 412, “Switch to on-ear headphones” 413, and “Toggle Discontinue/Resume External Speaker in Use Space” 414.

According to aspects of the present disclosure, with particular reference to FIG. 1, controller 110 may configure communication device 101 to communicate, via wireless transceiver 172, audio output signal 183 to external audio output device 184 positioned in use space 185. External audio output device 184 includes or is communicatively connected to external transceiver 187 in use space 185. Communication device 101 remains within communication range with external transceiver 187, and thus external audio output device 184, while inside use space 185 and also in exterior space 192 that is outside of use space 185. Controller 110 may configure communication device 101 to monitor the sensor that detects a sensor input that indicates a position of communication device 101. Examples of the sensor include microphone 156, received signal strength sensor 178 and UWB transceiver 180, which are discussed below. In response to a sensor input indicating that a position of communication device 101 has moved from inside to outside of use space 185 (i.e., exterior space 192), controller 110 may configure communication device 101 to discontinue communicating audio output signal 183 to external audio output device 184 via external transceiver 187.

In one or more embodiments, in response to determining that the position of communication device 101 has moved from inside to outside of use space 185, controller 110 configures communication device 101 to communicate audio output signal 183 to a designated “first” local audio output device, which may be wearable audio output device 182 if being worn by user 181 or otherwise to integral audio output device 164. In one or more particular embodiments, controller 110 configures communication device 101 to communicate audio output signal 183 to the first audio output device (e.g., integral audio output device 164 or wearable audio output device 182) further in response to determine that audio output signal 183 is associated with a live communication session, such as a phone call with user 181. In one or more particular embodiments, controller 110 configures communication device 101 to pause communication of audio output signal 183 in response to determining that audio output signal 183 is entertainment content (e.g., music, podcast, audiobook, etc.). In one related embodiment, controller 110 configures communication device 101 to pause communication of audio output signal 183 of entertainment content in response to determining (e.g., based on information received from in-vehicle sensors or from embedded device sensors monitoring the environment while the device is located within the use space) that there is no other person within the use space 185 who is listening to the audio output.

In one or more embodiments, in response to determining, based on a second change in the sensor input, that the position of communication device 101 has moved from outside (i.e., external space 192) to inside of use space 185, controller 110 configures communication device 101 to resume communicating audio output signal 183 to external audio output device 184.

In one or more embodiments, use space 185 is an occupant enclosure (e.g., vehicle or room) defined by occupant enclosure 190. Controller 110 configures communication device 101 to identify a sound characteristic of senso input to microphone 156 as an internal sound context within the occupant enclosure defined by occupant enclosure 190. Controller 110 configures communication device 101 to detect the change in the sensor input based on a magnitude of one or more types of sound content changing more than a respective threshold, indicating an external sound context (i.e., communication device 101 is most likely located outside of use space 185). The changes in magnitude may include matching or recognizing sound patterns characteristics that differ on each side of occupant enclosure 190. Sound patterns associated with exterior space 192 may include tire noise or engine noise from vehicles that are louder in exterior space 192 and attenuated in use space 185. Sound patterns associated with use space 185 may be spoken conversation and sounds produced by exterior audio output device 184 that are attenuated when in exterior space 192. The matching may be based on an abrupt change in interior sound being attenuated and exterior sounds being accentuated.

In one or more embodiments, controller 110 configures communication device 101 to monitor a receiver power sensor, such as received signal strength sensor 178 of wireless transceiver 172. In determining the change in the sensor input, controller 110 configures communication device 101 to detect a reduction in received signal strength of a wireless signal received by wireless transceiver 172 from external audio output device 184. The reduction below a specific threshold can then indicate that the communication device is no longer within/inside of use space 185.

In one or embodiments, controller 110 configures communication device 101 to communicate, via UWB transceiver 180 with second UWB transceiver 188 positioned in use space 185. UWB analysis provides the exact location or distance between the two UWB transceivers 180 and 188. In response to determining, based on communicating with second UWB transceiver 188, that a position of communication device 101 has moved from inside to outside of use space 185, controller 110 configures communication device 101 to discontinue communicating audio output signal 183 to external audio output device 184. The discontinuation may be based also on the context/type of the audio output (e.g., phone call versus streaming music) and the context of use space 185 (e.g., whether there is another person 191 still in user space 185 consuming the audio output), etc.

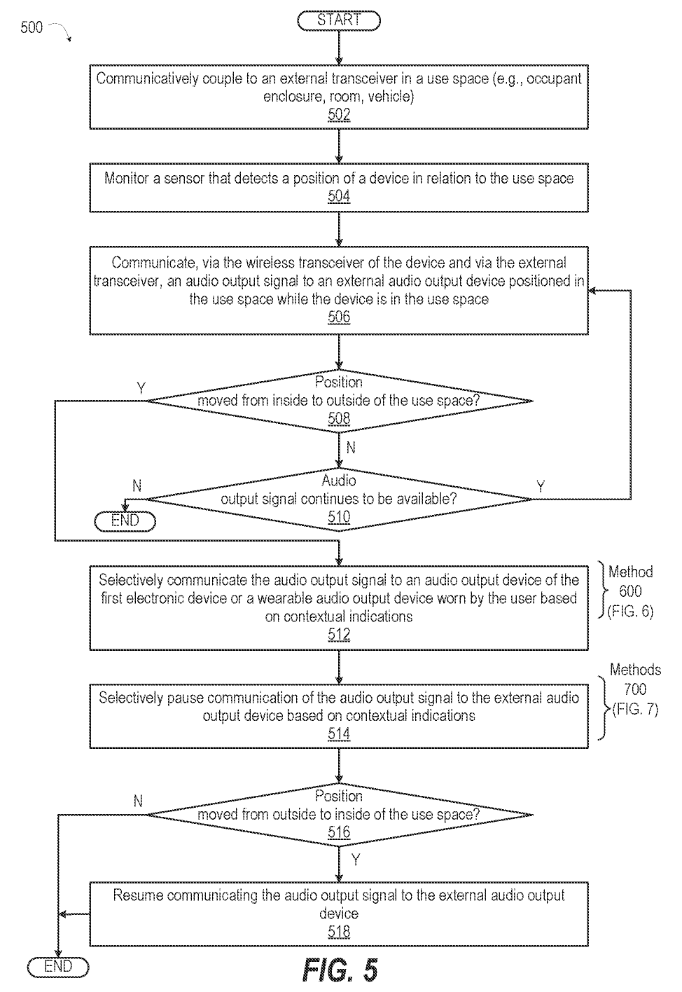

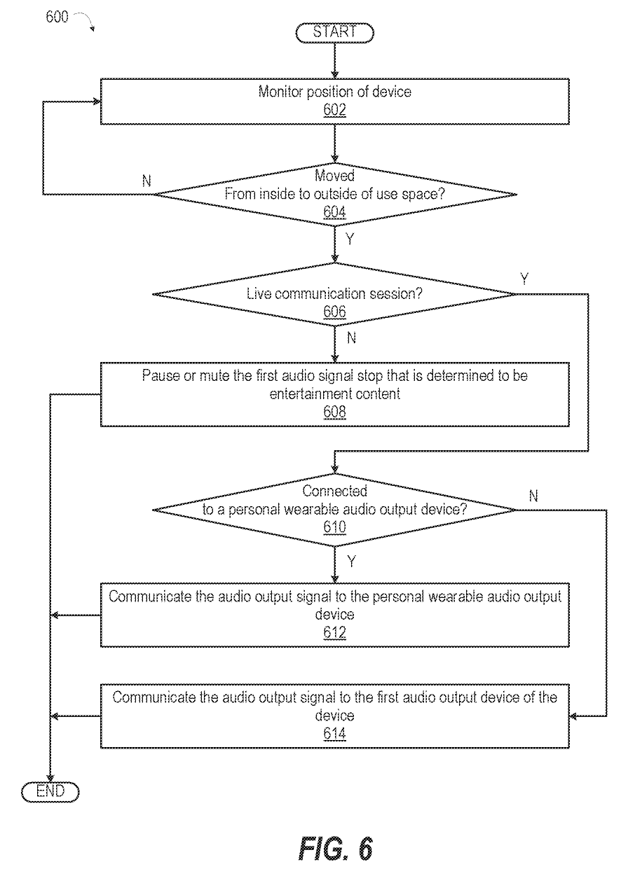

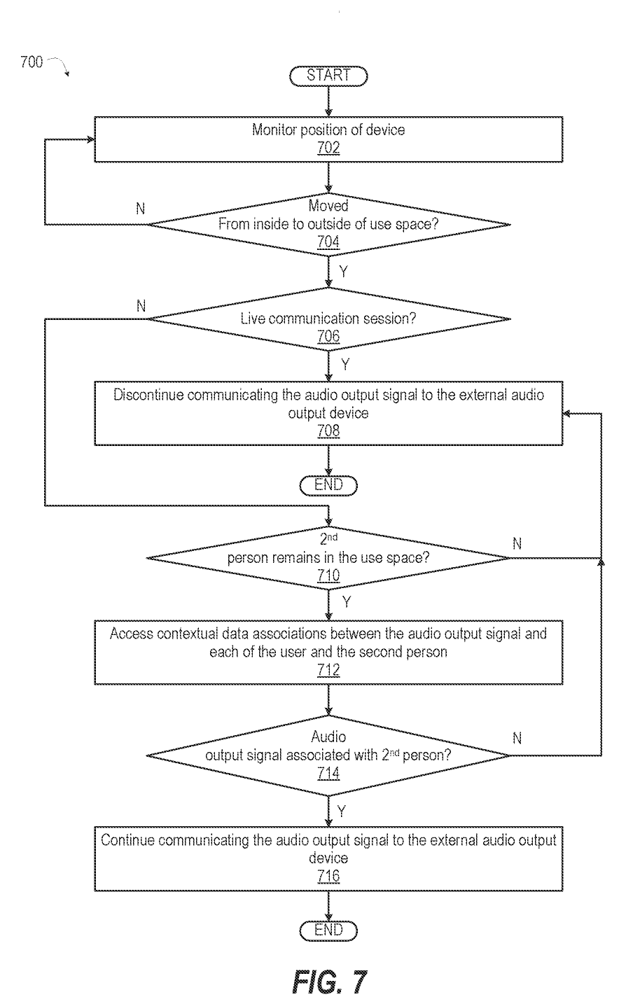

FIG. 5 is a flow diagram presenting method 500 of automatic pausing or switching of an audio output from an external audio output device to an integrated or wearable audio output device based on sensing relative device position to a use space such as an occupant enclosure, vehicle, or room. FIG. 6 is a flow diagram presenting method 600 of selectively communicating the audio output signal to an integrated audio output device of the first electronic device or a wearable audio output device worn by the user. FIG. 7 is a flow diagram of method 700 of selectively pausing communication of the audio output signal to the external audio output device based on contextual indications. Methods 600 and 700 of FIG. 5 and FIG. 7 augment method 500 (FIG. 5). The descriptions of method 500 (FIG. 5), method 600 (FIG. 6), and method 700 (FIG. 7) are provided with general reference to the specific components illustrated within the preceding FIGS. 1 –4. Specific components referenced in 500 (FIG. 5), method 600 (FIG. 6), and method 700 (FIG. 7) may be identical or similar to components of the same name used in describing preceding FIGS. 1 –4. In one or more embodiments, controller 110 (FIG. 1) configures communication device 101 (FIG. 1) or a similar computing device to provide the described functionality of method 500 (FIG. 5), method 600 (FIG. 6), and method 700 (FIG. 7).

With reference to FIG. 5, method 500 includes communicatively coupling, via a wireless transceiver of the communication device, to an external transceiver in a use space (block 502). Method 500 includes monitoring a sensor that detects a position of the communication device in relation to the use space (e.g., occupant enclosure, room, vehicle) (block 504). Method 500 includes communicating, via the wireless transmitter of the communication device and via the external transceiver, an audio output signal to an external audio output device positioned in the use space while the device is in the use space (block 506). Method 500 includes determining whether a change in a sensor input (e.g., acoustic, wireless signal strength, ultra-wideband (UWB) position finding) indicates that a position of the device has moved from inside to outside of the use space (decision block 508).

In one or more embodiments, the sensor is a microphone, and method 500 may further include identifying a sound characteristic of the sensor input to the microphone as an internal sound context within the occupant enclosure. Method 500 may further include detecting the change in the sensor input based on a magnitude of one or more types of sound content changing more than a respective threshold, which indicates the device being exposed to an external sound context. In one or more embodiments, the sensor includes a receiver power sensor of the wireless transceiver, and method 500 may further include determining the change in the sensor input by detecting a reduction in received signal strength of a wireless signal received by the wireless transceiver from the external audio output device. In one or more embodiments, method 500 may further include communicating, via a first UWB transceiver of the device, with a second UWB transceiver positioned in the use space, in order to accurately identify a position/location of the communication device relative to being inside or outside of the use space.

With continued reference to FIG. 5, in response to determining that no change in a sensor input has occurred, which indicates that a position of the device has not moved from inside to outside of the use space, method 500 includes determining whether the audio output signal continues to be available (decision block 510). In response to determining that the audio output signal continues to be available, method 500 returns to block 506. In response to determining that the audio output signal is no longer available, method 500 ends.

In response to a change in a sensor input indicating that a position of the device has moved from inside to outside of the use space, while the external audio output device remains within a communication range with the wireless transceiver, method 500 may include selectively communicating the audio output signal to an internal audio output device of the first electronic device or to a wearable audio output device worn by the user, based on other contextual indications (block 512). An example of a context that triggers selectively communicating the audio output signal to the audio output device of the first electronic device or the wearable audio output device worn by the user of block 512 is provided by method 600 of FIG. 6.

With continuing reference to FIG. 5, method 500 may include selectively pausing communication of the audio output signal to the external audio output device, based on contextual indications (block 514). In one or more embodiments, the communication of the audio output signal is paused to the external audio output device based at least in part on detecting that no other person is present within the use space (e.g., room or vehicle). Presence of a person may be detected by image recognition, a motion sensor, a microphone, weight sensor in a seat, etc. In one or more embodiments, the communication of the audio output signal is paused to the external audio output device based at least in part on detecting that the audio output signal is entertainment content (e.g., music, podcast, lecture, etc.). In one or more embodiments, the communication of the audio output signal is paused to the external audio output device based at least in part on detecting that the audio output signal is an audio recording and is not live. In one or more embodiments, the communication of the audio output signal is paused to the external audio output device based at least in part on detecting that one or more people remaining in the use space do not have a preference for the audio output signal to continue to be presented in the absence of the user. In one or more embodiments, the communication of the audio output signal is paused to the external audio output device based at least in part on detecting a user setting that the user prefers that the audio output signal be paused when the user is outside of the use space. Combinations of these contextual indicators may be used to trigger pausing or continued presentation of the audio output signal at the external audio output device. An example of selectively pausing communication of the audio output signal to the external audio output device of block 514 is provided by method 700 of FIG. 7.

With continuing reference to FIG. 5, in one or more embodiments, method 500 includes determining whether a second change in a sensor input indicates that a position of the device has moved from outside to inside of the use space (decision block 516). In response to determining, based on the second change in the sensor input, that the position of the device has moved from outside to inside of the use space, method 500 nay further include resuming communicating the audio output signal to the external audio output device block 518). In response to determining, based on the sensor input, that the position of the device has not moved from outside to inside of the use space in decision block 516 or after resuming communicating in block 518, method 500 ends.

With reference to FIG. 6, method 600 includes monitoring position of a device (block 602). Method 600 includes determining whether the position of the device has moved from inside to outside of the use space (decision block 604). In response to determining that the position of the device has not moved from inside to outside of the use space, method 600 returns to block 602. In response to determining that the position of the device has moved from inside to outside of the use space, method 600 includes determining whether the first audio signal is associated with a live communication session (block 606). In an example, a communication application, such as a phone call or video call application, that provides the first audio signal is associated with live communication sessions. Conversely, a media playback application that may provide the first audio signal is not associated with live communication sessions. In response to determining that the first audio signal is not associated with a live communication session, method 600 includes pausing or muting the first audio signal, which is considered entertainment content (block 608). Then method 600 ends. In response to determining that the first audio signal is associated with a live communication session, method 600 includes determining whether the device is communicatively connected to a personal wearable audio output device (decision block 610). In response to determining that the device is communicatively connected to a personal wearable audio output device that is on person of or being carried by the user, method 600 includes communicating the audio output signal to the personal wearable audio output device of the device (block 612). Then method 600 ends. In response to determining that the device is not communicatively connected to a personal wearable audio output device, method 600 includes communicating the audio output signal to a first integral audio output device of the device (e.g., integral speaker or loudspeaker) (block 614). Then method 600 ends.

With reference to FIG. 7, method 700 includes monitoring position of a device (block 702). Method 700 includes determining whether the position of the device has moved from inside to outside of the use space (decision block 704). In response to determining that the position of the device has not moved from inside to outside of the use space, method 700 returns to block 702. In response to determining that the position of the device has moved from inside to outside of the use space, method 700 includes determining whether the audio output signal is a live communication session (decision block 706). In response to determining that the audio output signal is a live communication session, method 700 includes discontinuing communicating the audio output signal to the external audio output device (block 708). Then method 700 ends. In response to determining that the audio output signal is not a live communication session, method 700 includes determining whether a second person remains in the use space (decision block 710). The determination can be based on recent monitoring of one or more visual, motion, audio, and seat weight sensors (i.e., air bag control sensor) within the use space. In response to determining that a second person does not remain within the use space, method 700 returns to block 708. In one or more embodiments, method 700 may include providing a recommendation to the user via a visual or audio prompt that the user may accept via a user interface. In response to determining that a second person does remain within the use space, method 700 includes accessing contextual data associations between the audio output signal and each of the user and the second person (block 712). In another example, association data may be based on visual or audio indications of user controls received at the communication device that are affirmatively determined to originate by a person other than the recognized user. Method 700 includes determining whether the audio output signal is associated with the second person (decision block 714). In response to determining that audio output signal is associated with the second person, method 700 return to block 706. In response to determining that the audio output signal is not associated with the second person, method 700 includes continuing communication of the audio output signal to the exterior audio output device (block 716). Then method 700 ends.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an" and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A device comprising:
a communication subsystem comprising a wireless transceiver;
a sensor; and
a controller communicatively coupled to the communication subsystem and the sensor, and which configures the device to:
communicate, via the wireless transceiver, an audio output signal to an external audio output device positioned in a use space;
monitor a sensor input detected by the sensor; and
in response to a change in the sensor input indicating that a position of the device has moved from inside to outside of the use space and while the external audio output device is within a communication range with the wireless transceiver, discontinue communicating the audio output signal to the external audio output device.

2. The device of claim 1, further comprising a first audio output device communicatively coupled to the controller, and, in response to determining that the position of the device has moved from inside to outside of the use space, the controller configures the device to communicate the audio output signal to the first audio output device.

3. The device of claim 2, wherein the controller configures the device to:
communicate the audio output signal to the first audio output device further in response to determine whether the first audio signal is associated with a live communication session.

4. The device of claim 2, wherein the controller configures the device to:
pause communication of the audio output signal in response to determining that the first audio signal comprises entertainment content.

5. The device of claim 1, wherein the controller configures the device to:
in response to determining, based on a second change in the sensor input, that the position of the device has moved from outside to inside of the use space, resume communicating the audio output signal to the external audio output device.

6. The device of claim 1, wherein the use space comprises an occupant enclosure.

7. The device of claim 6, wherein the sensor comprises a microphone, and the controller configures the device to:
identify a sound characteristic of the sensor input to the microphone as an internal sound context within the occupant enclosure; and
detect the change in the sensor input based on a magnitude of one or more types of sound content changing more than a respective threshold, indicating an external sound context.

8. The device of claim 1, wherein the sensor comprises a receiver power sensor of the wireless transceiver, and, in determining the change in the sensor input, the controller configures the device to detect a reduction in received signal strength of a wireless signal received by the wireless transceiver from the external audio output device.

9. The device of claim 1, wherein the communication subsystem further comprises a first ultra-wideband (UWB) transceiver, and the controller configures the first device to:
communicate, via the first UWB transceiver with a second UWB transceiver positioned in the use space; and
in response to determining, based on communicating with the second UWB transceiver, that a position of the device has moved from inside to outside of the use space, discontinue communicating the audio output signal to the external audio output device.

10. A method comprising:
communicating, via a wireless transceiver of a device, an audio output signal to an external audio output device positioned in a use space; and
in response to a change in a sensor input indicating that a position of the device has moved from inside to outside of the use space and while the external audio output device is within a communication range with the wireless transceiver, discontinuing communicating the audio output signal to the external audio output device.

11. The method of claim 10, further comprising:
in response to determining that the position of the device has moved from inside to outside of the use space, communicating the audio output signal to a first audio output device of the device.

12. The method of claim 11, further comprising:
communicating the audio output signal to the first audio output device further in response to determine whether the first audio signal is associated with a live communication session.

13. The method of claim 11, further comprising:
pausing communication of the audio output signal in response to determining that the first audio signal comprises entertainment content.

14. The method of claim 10, further comprising:
in response to determining, based on a second change in the sensor input, that the position of the device has moved from outside to inside of the use space, resuming communicating the audio output signal to the external audio output device.

15. The method of claim 10, wherein the use space comprises an occupant enclosure.

16. The method of claim 15, wherein the sensor comprises a microphone, and the method further comprises:
identifying a sound characteristic of the sensor input to the microphone as an internal sound context within the occupant enclosure; and
detecting the change in the sensor input based on a magnitude of one or more types of sound content changing more than a respective threshold indicating an external sound context.

17. The method of claim 10, wherein the sensor comprises a receiver power sensor of the wireless transceiver, and determining the change in the sensor input comprises detecting a reduction in received signal strength of a wireless signal received by the wireless transceiver from the external audio output device.

18. The method of claim 10, further comprising:
communicating, via a first ultra-wideband (UWB) transceiver of the device, with a second UWB transceiver positioned in the use space; and
in response to determining, based on communicating with the second UWB transceiver, that a position of the device has moved from inside to outside of the use space, discontinuing communicating the audio output signal to the external audio output device.

19. A computer program product comprising:
a computer readable storage device; and
program code on the computer readable storage device that when executed by a processor associated with an electronic device, the program code configures the electronic device to provide functionality of:
communicating, via a wireless transceiver of a device, an audio output signal to an external audio output device positioned in a use space; and
in response to a change in a sensor input indicating that a position of the device has moved from inside to outside of the use space and while the external audio output device is within a communication range with the wireless transceiver, discontinuing communicating the audio output signal to the external audio output device.

20. The computer program product of claim 19, wherein the use space comprises an occupant enclosure.
